(19) United States
(12) Patent Application Publication
(10) Pub. No.: US 2026/0016943 A1
(43) Pub. Date: Jan. 15, 2026

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: KEITA GOTO, Tokyo (JP)

(21) Appl. No.: 19/235,891

(22) Filed: Jun. 12, 2025

(30) Foreign Application Priority Data
Jul. 10, 2024 (JP) 2024-111066

(51) Int. Cl. G06F 3/04847; G06F 3/0481; G06F 3/0487; H04N 1/00

(52) U.S. Cl. CPC G06F 3/04847; G06F 3/0481; G06F 3/0487; H04N 1/00411; H04N 1/0048; H04N 1/00514

(57) ABSTRACT

An information processing apparatus includes one or more processors and/or circuitry which function as: a display control unit configured to display an application button representing a function among plural functions in a predetermined area; a moving unit configured to move positions of a plurality of the application buttons displayed by the display control unit; and a setting unit configured to, for each application button displayed in the predetermined area, set a movement setting indicating whether the application button is movable. In a case where an operation of moving a first application button, which is included within the predetermined area and is set to be movable by the setting unit, is received, the moving unit executes control to move the first application button and not to move a second application button being the application button included within the predetermined area and set to be immovable by the setting unit.

### BACKGROUND

### Field of the Technology

The present disclosure relates to an information processing apparatus, and a method of controlling an information processing apparatus, and a storage medium.

### Description of the Related Art

Home screens displayed on information processing apparatuses may display application buttons with images that are based on functions (hereinafter referred to as “application buttons”). There is a technique that changes the layout of these application buttons by setting whether to display or not to display an application button or buttons and/or moving an application button or buttons. There is also a personalization technique that saves an individual layout of application buttons for each of users, such as an administrator user responsible for management (administrator) and general users. Japanese Patent Laid-Open No. 2019-113999 discloses the following technique for an image forming apparatus capable of switching a screen to be displayed between a shared screen and an individual screen. In this technique, only application buttons that were determined necessary to be displayed on an individual screen at the time of installation of the applications are displayed on the individual screen. While general users cannot change the layout of the application buttons on the shared screen, they can freely change the layout of the application buttons on the home screen of the individual screen, which improves operability.

### SUMMARY

An information processing apparatus according to the present disclosure has a plurality of functions and includes one or more processors and/or circuitry which function as: a display control unit configured to display an application button representing a function among the plurality of functions in a predetermined area; a moving unit configured to move positions of a plurality of the application buttons displayed by the display control unit; and a setting unit configured to, for each of the plurality of application buttons displayed in the predetermined area, set a movement setting indicating whether the application button is movable, wherein, in a case where an operation of moving a first application button, which is included within the predetermined area and is set to be movable by the setting unit, is received, the moving unit executes control to move the first application button and not to move a second application button being the application button included within the predetermined area and set to be immovable by the setting unit.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram of a configuration of an image processing apparatus according to a first embodiment;

FIG. 2 is an exterior view of an operation unit according to a first embodiment;

FIGS. 3A, 3B, 3C, 3D, 3E, and 3F are diagrams illustrating screen transitions during a process of changing movement attribute information of application buttons;

FIGS. 4A, 4B, 4C, 4D, and 4E are diagrams illustrating screen transitions during the process of changing the movement attribute information of application buttons;

FIGS. 5A, 5B, 5C, 5D, 5E, and 5F are diagrams illustrating screen transitions during a process of moving application buttons;

FIGS. 6A, 6B, and 6C are diagrams illustrating a screen transition during the process of moving application buttons;

FIG. 7 is an information table illustrating movement attribute information of application buttons;

FIG. 8 is a flowchart of the process of changing the movement attribute information of application buttons;

FIG. 9 is a flowchart of the process of moving application buttons;

FIGS. 10A, 10B, and 10C are diagrams illustrating screen transitions during a process of changing movement attribute information of user groups;

FIGS. 11A, 11B, 11C, 11D, 11E, and 11F are diagrams illustrating screens displayed at a login involved in a process of changing movement attribute information of a user group;

FIG. 12 is an information table indicating user groups and administrator movement information of logged-in users;

FIG. 13 is a flowchart of a process of changing movement attribute information of user groups; and

FIG. 14 is a flowchart of a process of displaying screens for a logged-in user.

### DESCRIPTION OF THE EMBODIMENTS

Hereinafter, with reference to the attached drawings, the present disclosure is explained in detail in accordance with embodiments. The present disclosure is not limited to configurations shown in the following embodiments. In addition, the same components are denoted by the same reference numerals. Further, each process (step) in the flowcharts and the sequence charts is denoted by a reference numeral starting with S.

### First Embodiment

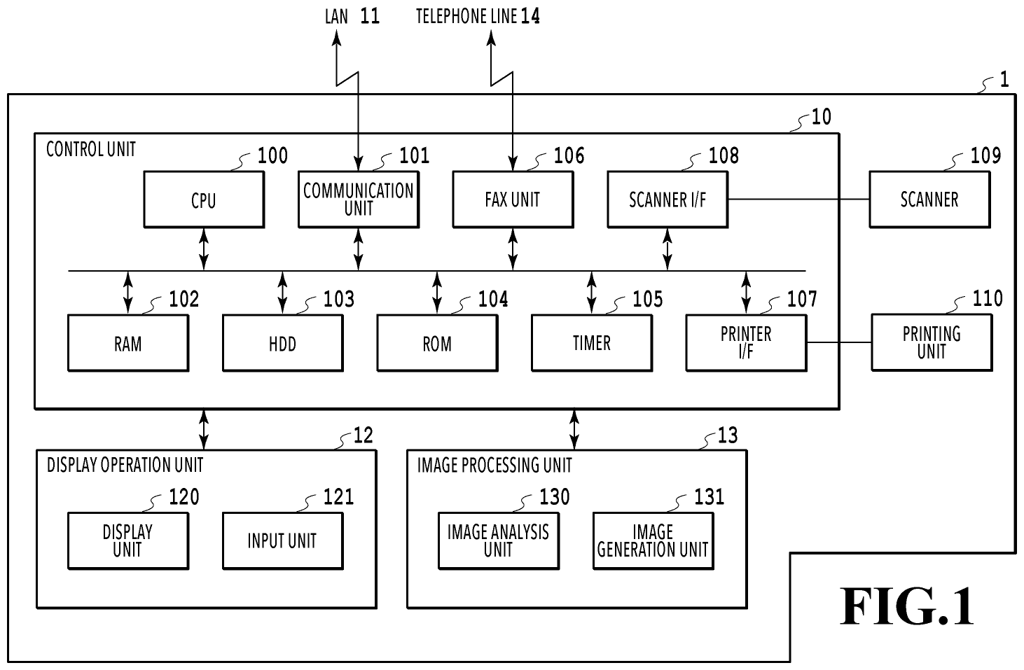

FIG. 1 is a block diagram describing a configuration of an image processing apparatus 1 as an example of an information processing apparatus according to a first embodiment. The image processing apparatus 1 is a multi function peripheral (MFP) printer having the following functions, for example. Incidentally, the image processing apparatus 1 may be a single function peripheral (SFP) printer, instead of an MFP printer. Note that the printing method of the image processing apparatus 1 may be an electrophotographic method, an inkjet method, or another method. Also, the information processing apparatus does not need to be an image processing apparatus, and may be a personal computer (PC), a tablet terminal, or a smartphone, for example.

The image processing apparatus 1 includes a control unit 10, a display operation unit 12, an image processing unit 13, a scanner 109, and a printing unit 110. The control unit 10 controls operation of units of the image processing apparatus 1. The control unit 10 includes a central processing unit (CPU) 100, a communication unit 101, a random-access memory (RAM) 102, a hard disk drive (HDD) 103, a read-only memory (ROM) 104, a timer 105, a fax unit 106, a scanner interface (I/F) 108, and a printer I/F 107.

The CPU 100 comprehensively controls the control unit 10. The RAM 102 functions as a work memory for the CPU 100. The HDD 103 stores application programs, image data, various data, and so on. The HDD 103 may be a storage medium such, for example, as a solid state drive (SSD), an optical medium, or a flash memory. Also, the HDD 103 may be configured to be removably installable to the image processing apparatus 1 as an external storage device, or may be a cloud storage. The ROM 104 stores a boot program, programs, and so on to be read out by the CPU 100. The timer 105 keeps track of time, is referred to by the CPU 100, and the CPU 100 obtains time information from the timer 105.

The communication unit 101 is connected to a local area network (LAN) 11 and controls sending and receiving of data through the LAN 11. The fax unit 106 is connected to a telephone line 14 and controls sending and receiving of data through the telephone line 14. The display operation unit 12 includes a display unit 120 to which a touch panel sheet is attached, and an input unit 121, such as hardware keys. The display unit 120 displays user interface (UI) screens and the like and receives operations from the user. The present embodiment will be exemplarily described on the assumption that the display unit 120 is a liquid crystal display, but the display unit 120 may be another type of display. The present embodiment will be exemplarily described on the assumption that the input unit 121 is a touch panel, and the display unit 120 and the input unit 121 are integrated with each other, but the configuration is not limited to this. The input unit 121 may receive user operations via another interface, such as a mouse. Also, the input unit 121 may be separate from the display unit 120.

The image processing unit 13 is controlled by the control unit 10 and includes an image analysis unit 130 and an image generation unit 131. The image analysis unit 130 analyzes the structures of document images and extract necessary information from the analysis results. The image generation unit 131 reads documents with the scanner 109 to digitalize images of the documents and generate image data. The generated image data is stored in the HDD 103. Also, using information analyzed by the image analysis unit 130, the image generation unit 131 can generate document image data in another format.

The image processing apparatus 1 has a copying function, a scanning function, and a printing function. The copying function is a function of reading image data of a document with the scanner 109 and printing an image based on the read image data of the document on a sheet with the printing unit 110. The scanning function is a function of sending image data generated by reading an image of a document with the scanner 109 to an external apparatus with the communication unit 101. The printing function is a function of printing an image based on print data received from an external information processing apparatus, such as a PC, via the communication unit 101 on a sheet with the printing unit 110.

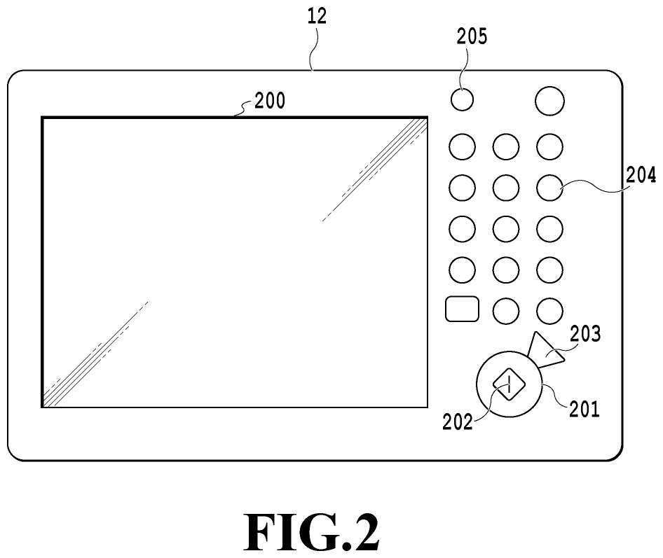

FIG. 2 is an exterior view of the display operation unit 12 in FIG. 1. In this example, a touch panel 200 is a liquid crystal display with a touch panel sheet attached thereto and displays objects, such as an operation screen and software keys. In a case where any of the displayed objects is selected by a pointer (e.g., the user's finger), the CPU 100 is informed of information on that position. In this way, the CPU 100 can determine which object or objects are selected by the user. Thus, the touch panel 200 in this case can be considered to function as the display unit 120 in FIG. 1 and also as the input unit 121. Note that the present embodiment will describe a configuration including the function of the touch panel 200 as the display unit 120, but the function of the touch panel 200 does not need to be included. For example, the display unit 120 may be configured to display screen transitions based on operations performed using a cursor or the like with a pointing device.

Next, various keys and buttons to be operated by the user will be described. A start key 201 is used to instruct the scanner 109 to start a document reading operation and for other similar purposes. At its center portion, the start key 201 has a light emitting diode (LED) 202 of two colors, namely green and red, and indicates whether the start key 201 is ready to use with these colors. A stop key 203 is used to stop an operation that is being performed. A ten key 204 includes number keys and symbol keys and are used to set the number of copies to be made and give an instruction to switch the screen on the touch panel 200. A user mode key 205 is used to call a user mode. The user mode is a mode for configuring settings of the image processing apparatus 1.

Next, functional blocks of the information processing apparatus according to the present embodiment will be described. A setting unit sets various settings, such as the movement attribute information and layout information of application buttons. Here, the layout information of application buttons means information defining the positions to arrange the application buttons. Also, the setting unit sets the size and numbers of application buttons per screen, and performs other similar operations. This setting may be done according to user operations or automatically. A mode change unit performs a process of changing a mode to a movement attribute information setting mode or a button moving mode depending on the situation and a process of transitioning to a normal mode in response to completion of processing in either mode. A display control unit controls the display operation unit 12 to display UI screens and the like on the display operation unit 12. A moving unit performs a process of moving the positions of plural application buttons displayed by the display control unit. Also, the control unit 10 comprehensively controls the information processing apparatus, as described above.

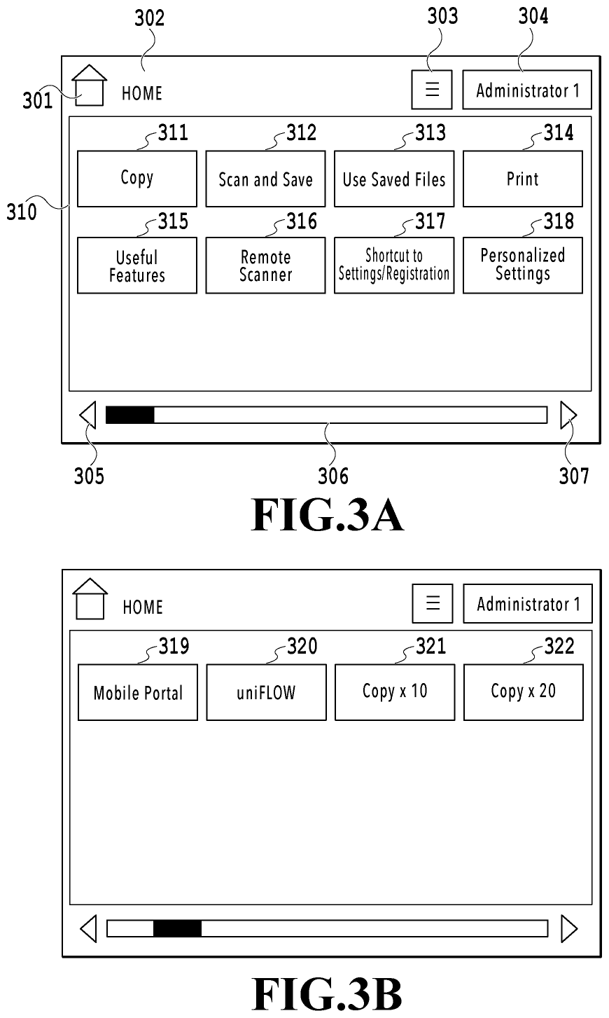

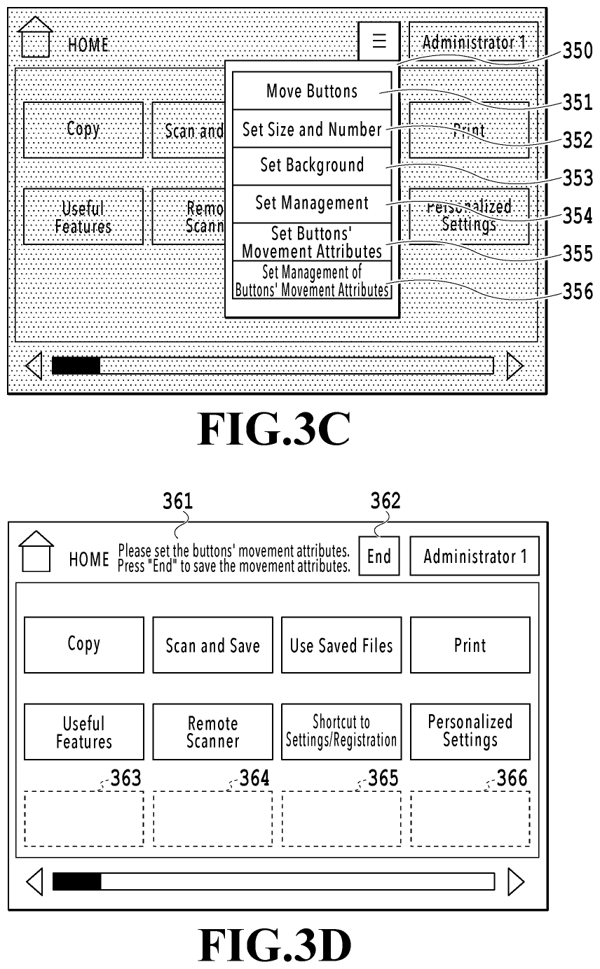

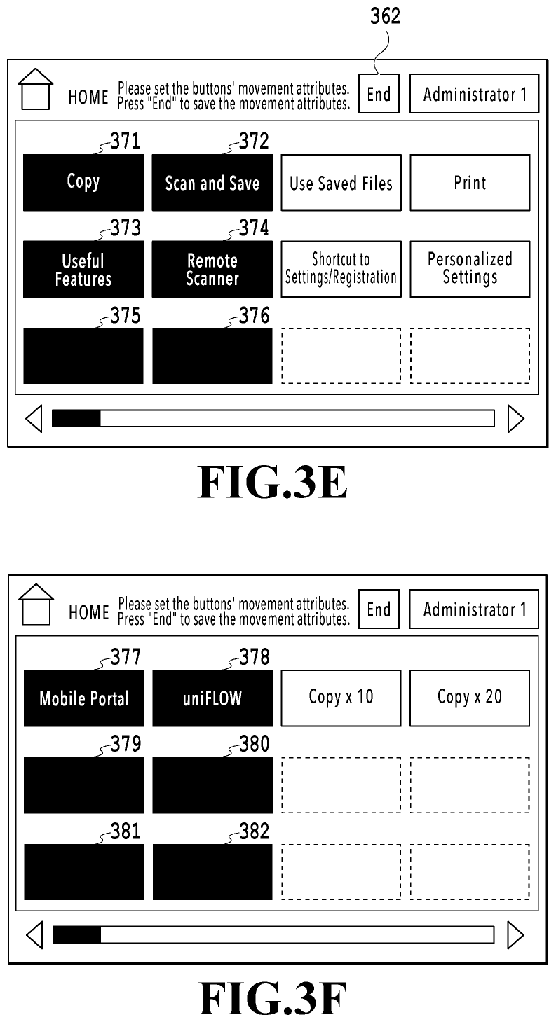

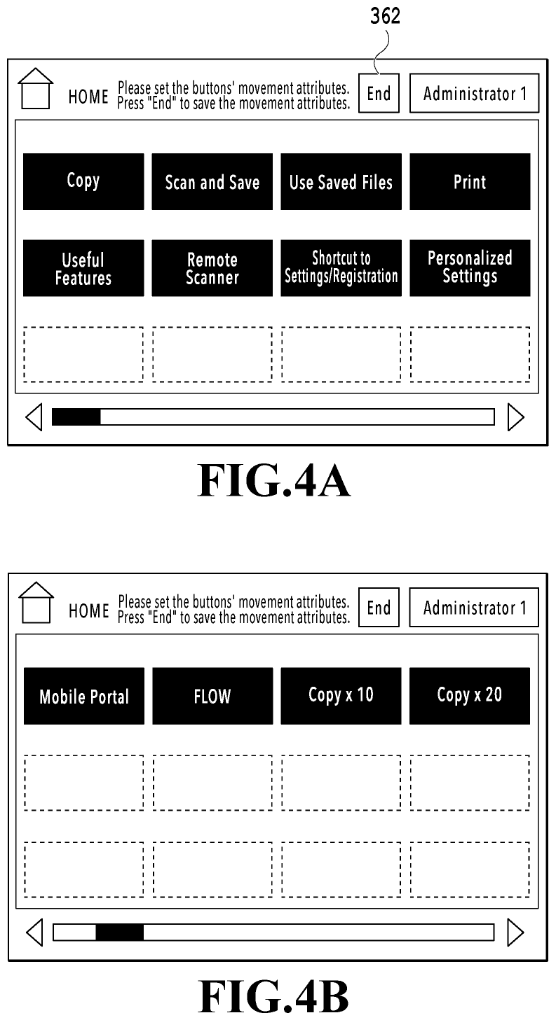

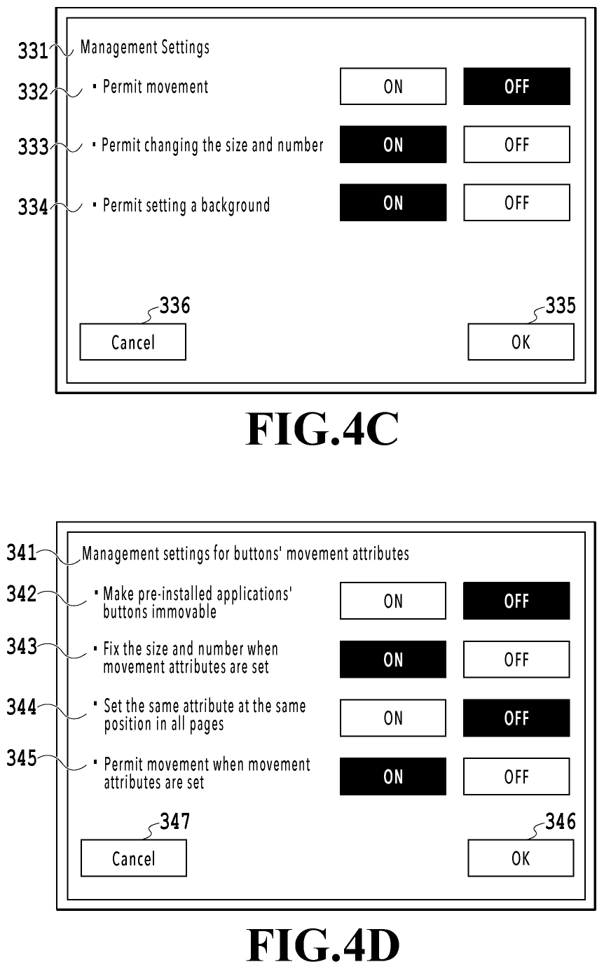

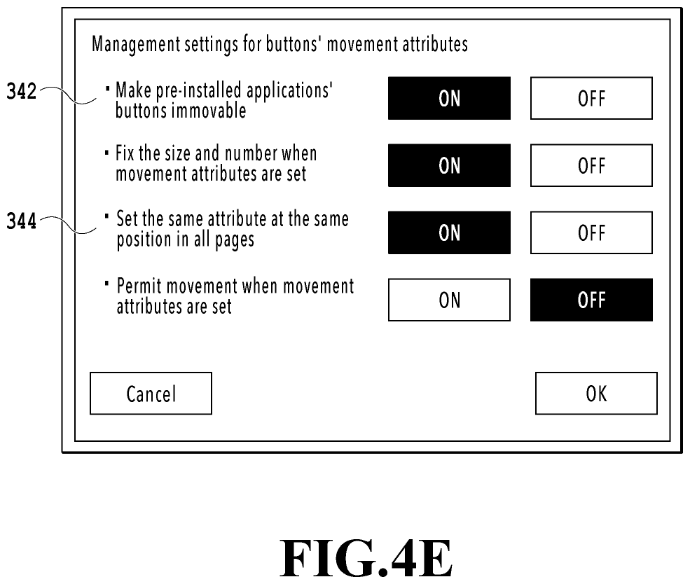

FIGS. 3A to 4E are diagrams illustrating screen transitions during a process of changing the movement attribute information of application buttons displayed on a home screen 302. FIGS. 3A, 3C, 3D, 3E, and 4A illustrate the first page of the home screen. FIGS. 3B, 3F, and 4B illustrate the second page of the home screen.

The home screen 302 illustrated in FIG. 3A is a screen which is displayed first on the display unit 120 after powering on the image processing apparatus 1 and completing a startup process, and on which the user can customize each application button. Note that the home screen 302 displayed on the display unit 120 may be a screen displayed based on a predetermined user operation. Each application button is a button (content or icon) for executing a function of the image processing apparatus 1. For example, in a case where an application button 311 representing copying is selected by a user operation, a setting screen for executing the copying function is displayed. That is, a function corresponding to the application button is activated. Note that the functions of the application buttons illustrated in FIGS. 3A to 3F may be different functions.

Note that, in the present embodiment, the following descriptions will be given with reference to FIG. 4C to be described later. Unlike general users, an administrator has authority to execute operations with functions that are restricted for general users. A description will be given of the display of screens after the administrator performs an operation for changing movement attribute information in a state where the administrator has prohibited movement of all application buttons by general users. The state where the administrator has prohibited movement of all application buttons by general users refers to a state where the setting value of a setting item 332 for setting whether to permit movement of the application buttons is OFF. A description will be given of the display of screens in a case of moving application buttons with a user operation which have become movable as a result of the administrator performing the operation for changing movement attribute information in the above-described state.

The home screen 302 will now be specifically described using FIGS. 3A and 3B as an example. FIG. 3A is a display example of the head (first) page of the home screen 302 displayed on the touch panel 200. FIG. 3B is a display example of the second page of the home screen 302 displayed on the touch panel 200. The home screen 302 includes an application button display area 310 including application buttons 311 to 322 for activating applications. In the application button display area 310, the application buttons 311 to 322 are displayed in an aligned manner. The application buttons are application buttons that have been customized by a user currently logged in to the image processing apparatus 1 (logged-in user) and are displayed in a layout determined by the user based on logged-in user information being information on the user. In the example of FIGS. 3A and 3B, the application buttons 311 to 320 represent applications that were installed in the main body in advance. The application buttons 321 and 322 represent application buttons for which setting values set by the user are registered in association with their respective functions.

For each application button, a name indicating the function of the application button and its icon (an image indicating the function of the application button) are displayed. Note that both the name and the icon indicating the function of the application button may be displayed, or at least one of them may be displayed. Also, each application button may be one with a name placed outside an icon being an image indicating the function. While the present embodiment will exemplarily describe processing with application buttons having predetermined functions, the application buttons may be replaced with contents having the predetermined functions.

A home icon 301 is a button representing the home screen 302. For example, a screen different from the home screen 302 transitions to the home screen 302 in a case where the home icon 301 displayed on the screen is operated. A menu button 303 is a button for displaying a setting area where settings of the home screen can be configured. Pressing the menu button 303 displays a list of setting items for the home screen 302. The currently logged-in user name is displayed in an area 304. Note that FIGS. 3A to 3D illustrate a case where “Administrator 1” is logged in. Pressing the area 304 performs a logout process on currently logged-in user information, but a separate logout button may be provided. A slider bar 306 is used to switch the displayed page through a slide operation toward the left or right. For example, a slide operation on the slider bar 306 toward the right displays the next page to the currently displayed page in the application button display area 310. In a case where an operation for displaying a page following or preceding the currently displayed page is performed, the CPU 100 calls a screen including predetermined application buttons from the HDD 103 and displays them in the application button display area 310 in accordance with the operation. The following are examples of the operation for displaying a page following or preceding the currently display page. The examples include an operation of sliding the slider bar toward the left or right, an operation of pressing an arrow 305 for moving to a page preceding the currently display page, and an operation of pressing an arrow 307 for moving to a page following the currently display page. Other examples include an operation of either flicking or scrolling an area within the application button display area 310 toward the next or previous page.

FIG. 3C illustrates the home screen 302 displaying a context menu 350 as a result of pressing the menu button 303 in FIG. 3A or 3B. The context menu 350 displays setting items for the home screen 302. The setting items include a movement button 351, a size and number setting button 352, a background setting button 353, a management setting button 354, a movement attribute information setting button 355, and a movement attribute information management setting button 356. The movement button 351 is a button that allows movement of the positions of the application buttons displayed on the home screen 302. The size and number setting button 352 is a button for changing the number of application buttons to be displayed per page and the size of the buttons. The background setting button 353 is a button for changing the background image displayed as the background of the home screen 302. The management setting button 354 is a button for changing settings for management of the home screen 302. The movement attribute information setting button 355 is a button for changing the movement attribute information of the application buttons displayed on the home screen 302. The movement attribute information management setting button 356 is a button for changing management settings for the movement attribute information of the application buttons displayed on the home screen 302. Note that the operation for displaying the movement button 351 to the movement attribute information management setting button 356 may be, for example, a right click on a pointing device in a case where the display unit 120 does not have a touch panel function.

FIG. 3D illustrates a state where the movement attribute information of the application buttons displayed on the home screen 302 has become settable on the home screen 302 as a result of pressing the movement attribute information setting button 355, which is a setting item for the home screen. This state will be referred to as “movement attribute information setting mode”. In the movement attribute information setting mode, guidance 361 indicating that the screen has transitioned to the movement attribute information setting mode, and an end button 362 for confirming the movement attribute information are displayed. The guidance 361 presents a message instructing the user to select, for each application button, whether to set the application button to a movable state or to an immovable state. For example, a message “Please set the movement attribute information of the buttons. Press “End” to save the movement attribute information.” or the like is displayed. The setting of the movement attribute information is initially such that all application buttons are movable, for example. Pressing an application button in the movement attribute information setting mode sets the movement attribute information of the pressed application button to information indicating that the application button is immovable.

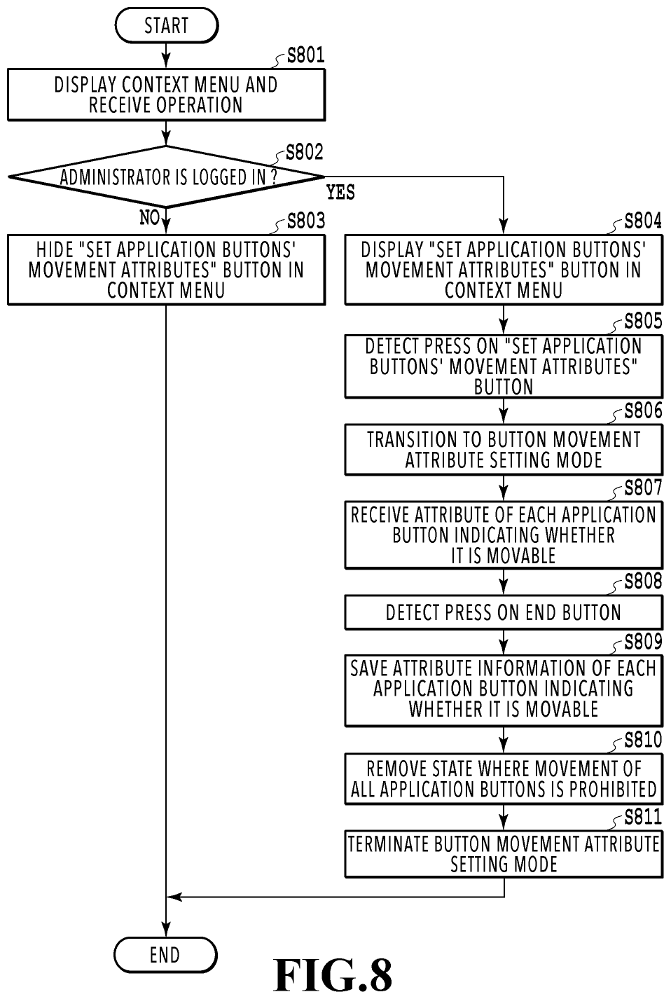

In the movement attribute information setting mode, it is possible to change the movement attribute information of one or more application buttons. For example, it is possible to set the movement attribute information of one or more application buttons to “immovable” and set the movement attribute information of one or more application buttons to “movable”. Also, in a case where a setting for prohibiting (not permitting) movement of the application buttons is enabled (the setting item 332 “Permit movement” in FIG. 4C to be described later is turned off), the following operation is performed as well. In a case where there is an application button whose movement attribute information has been updated from “immovable” to “movable” and the movement attribute information setting mode is terminated, control to disable (turn on) the setting item 332 prohibiting movement of this application button is performed as well (S810 in FIG. 8).

Note that the trigger to transition to the movement attribute information setting mode does not need to be pressing the movement attribute information setting button 355. For example, transition to the movement attribute information setting mode may be triggered by a long press on an application button or on an area of the home screen 302 where no application button is arranged. The movement attribute information setting button 355 may be displayed, for example, at a predetermined position on the home screen 302 instead of in the context menu 350. Note that the configuration may be such that the movement attribute information setting button 355 is not displayed on the home screen 302. Also, in the movement attribute information setting mode, blank buttons 363 to 366 which are not assigned functions of the image processing apparatus 1 are displayed. In the movement attribute information setting mode, the blank areas (buttons) 363 to 366 depicted with the dotted lines can receive operations like those on the application buttons (e.g., drag operations and drop operations on the blank buttons). In a case where the movement attribute information setting mode is disabled, the blank buttons are displayed on the home screen 302 as blank spaces indicating a state where application buttons are allowed to be arranged there but are not.

FIGS. 3E and 3F illustrate a state where application buttons 371 to 382 are given the movement attribute information representing “immovable” in a state where the setting value of a setting item 342 for making pre-installed application buttons, which are the buttons of pre-installed applications, immovable is turned off. This will also be described in the following section with FIG. 4D. The movement attribute information representing “movable” may be set to custom buttons added by user operations, or the movement attribute information representing “immovable” may be set to them. Also, a setting item that allows either type of movement attribute information to be set to custom buttons by default may be displayed.

Also, while the state of FIGS. 3E and 3F can be reached by selecting all of the application buttons 371 to 382, not all of the application buttons need to be selected. For example, consider a case where the screen includes plural pages. To set the movement attribute information representing “immovable” at the same position in all pages, the setting value of a setting item 344 for setting whether to set the same movement attribute information at the same position in all pages in FIG. 4E to be described later may be set to ON. Selecting the application buttons 371 to 376 in FIG. 3E after setting this setting value to ON will automatically select the application buttons 377 to 382 in FIG. 3F.

FIGS. 4A and 4B illustrates a state of having transitioned to the movement attribute information setting mode in a state where the setting value of the setting item 342 in FIG. 4D to be described later for making the pre-installed application buttons immovable is turned on. In this state, immovable application buttons may further be set. Note that pressing the end button 362 in the movement attribute information setting mode saves the settings of the movement attribute information of the application buttons, terminates the movement attribute information setting mode, and displays the home screen 302 in FIG. 3A or 3B. Incidentally, in a case where an operation that discards the screen of the movement attribute information setting mode, such as powering off the image processing apparatus 1 without pressing the end button 362, the movement attribute information given during the movement attribute information setting mode is discarded without being saved. Note that the movement attribute information does not need to be discarded even in the case where an operation that discards the screen is performed if the system is capable of saving the movement attribute information settings at the same time as when they are changed in the movement attribute information setting mode. Also, instead of saving the movement attribute information settings immediately after the end button 362 is pressed, a screen that allows the user to select whether to save or not to save the movement attribute information settings may be displayed. An option to save the movement attribute information set by selected operations or to discard the set movement attribute information may be provided. A system capable of changing the number of application buttons to be displayed may be configured as below. The number of application buttons to be displayed may be set at the same time as when the movement attribute information settings are saved in a state where a setting item 343 in FIG. 4D to be described later for setting whether to fix the size and number of application buttons in a case where the movement attribute information is set is turned off.

FIG. 4C illustrates a management setting screen 331 on which setting items required for the management of the home screen 302 are displayed as a result of pressing the management setting button 354 in FIG. 3C and on which the settings of these setting items can be changed. The management setting screen 331 includes the setting item 332 for setting whether to permit movement of the application buttons by general users, a setting item 333 for setting whether to permit changing the size and number of application buttons, and a setting item 334 for setting whether to permit setting a background. The setting items 332 to 334 each have a button which displays its current setting value such that whether it is ON or OFF is recognizable, and which also can switch the setting value. Also, the management setting screen 331 includes an OK button 335 for saving the setting values in a case where any of the settings on this screen is changed, and a cancel button 336 for discarding the setting value(s). The display example of FIG. 4C illustrates the management setting screen 331 prohibiting movement of the application buttons, permitting changing the size and number of application buttons, and permitting setting a background.

FIG. 4D illustrates an application button movement attribute information management setting screen 341 on which setting items required for the management of the movement attribute information on the home screen 302 are displayed as a result of pressing the movement attribute information management setting button 356 in FIG. 3C and on which the settings of these setting items can be changed. The application button movement attribute information management setting screen 341 includes setting items 342 to 345. The setting item 342 is a setting item for setting whether to make the pre-installed application buttons immovable. The setting item 343 is a setting item for setting whether to fix the size and number of application buttons in a case where movement attribute information is set. The setting item 344 is a setting item for setting whether to set the same movement attribute information at the same position in all pages. The setting item 345 is a setting item for setting whether to automatically turn on the setting of the setting item 332 for setting whether to permit movement of the application buttons in a case where the movement attribute information settings are changed. The setting items 342 to 345 each have a button which displays its current setting value such that whether it is ON or OFF is recognizable, and which also can switch the setting value. Also, the application button movement attribute information management setting screen 341 includes an OK button 346 for saving the setting values in a case where any of the settings on this screen is changed, and a cancel button 347 for discarding the setting value(s). The display example of FIG. 4D illustrates the application button movement attribute information management setting screen 341 with the following settings. That is, the display example illustrates a state where the pre-installed application buttons are movable, and the size and number of application buttons are set to be fixed in a case where movement attribute information is set. Further, the display example illustrates a state where the same movement attribute information is not to be set at the same position in all pages, and movement of the application buttons in a case where the movement attribute information settings are changed is not permitted. In the case of fixing the size and number of application buttons, the settings of the size and number in FIG. 3C may be changed and also disabled to make the size and number setting button 352 unselectable.

FIG. 4E illustrates a state where the setting item 342 for making the pre-installed application buttons immovable is changed to ON and the setting item 344 for setting whether to set the same movement attribute information at the same position in all pages is changed to ON from the state of FIG. 4D. The display example of FIG. 4E illustrates the application button movement attribute information management setting screen 341 differing from the state of FIG. 4D in that the pre-installed application buttons are immovable and the same movement attribute information is to be set at the same position in all pages.

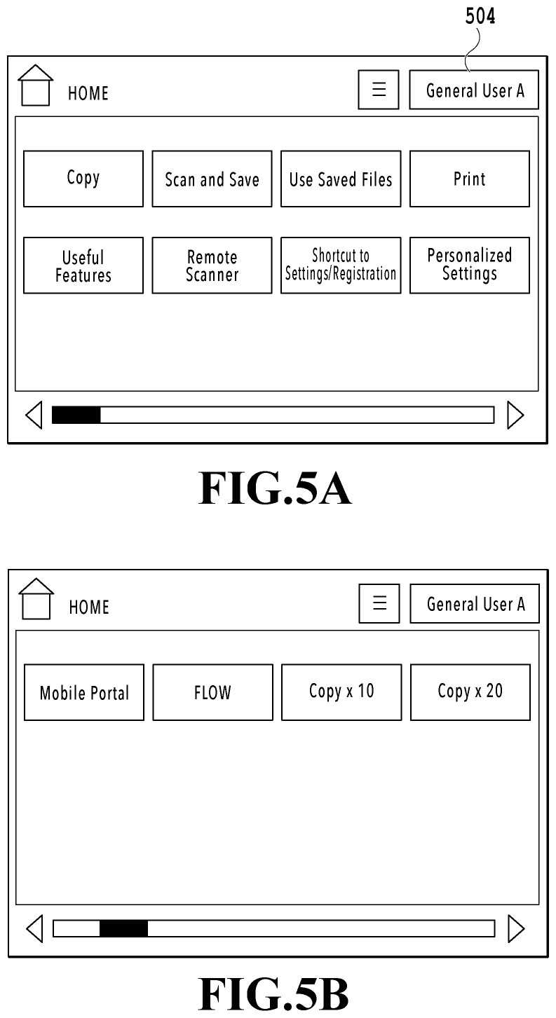

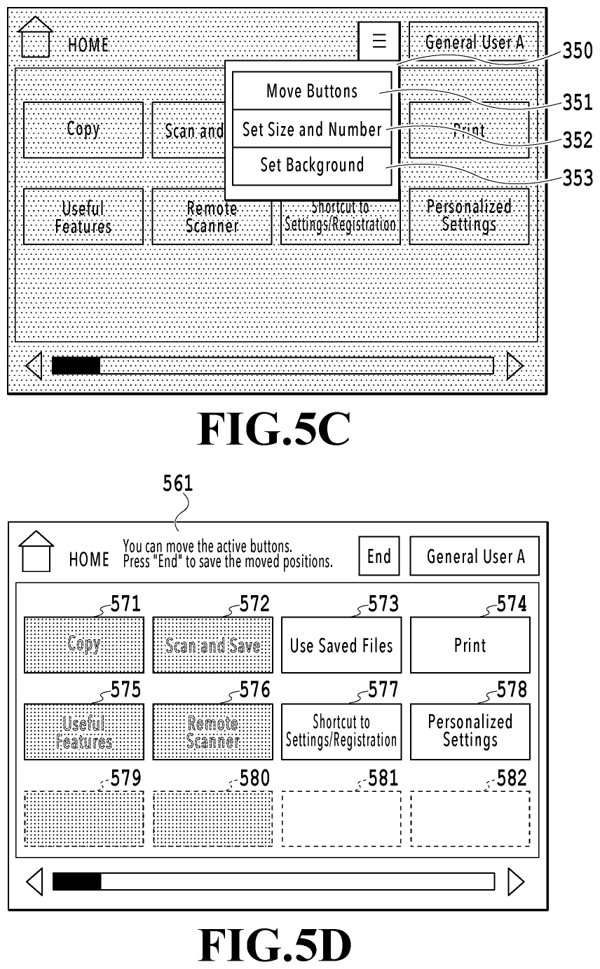

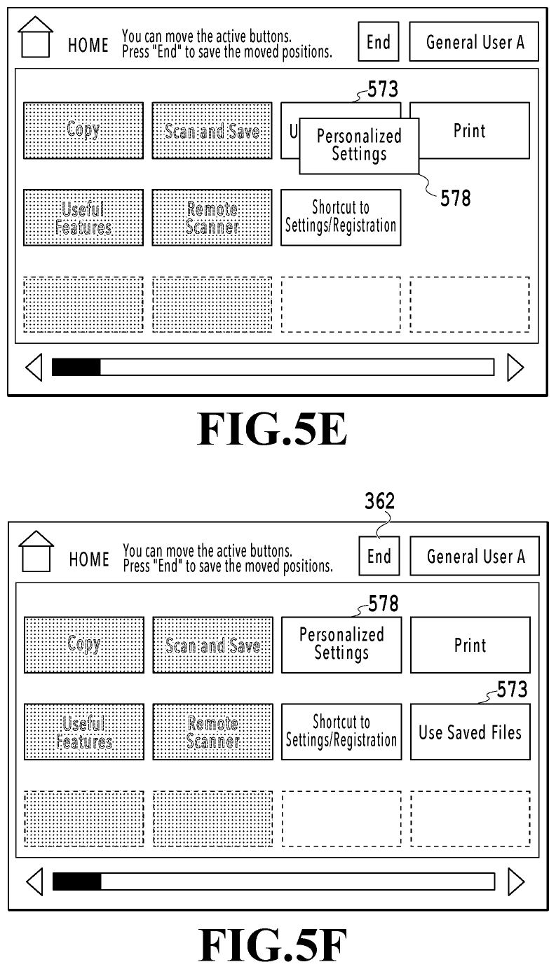

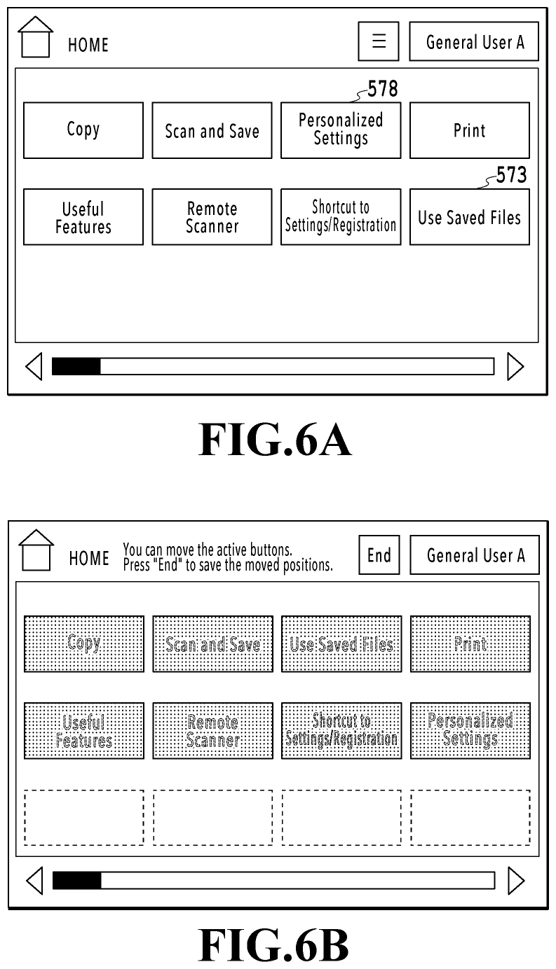

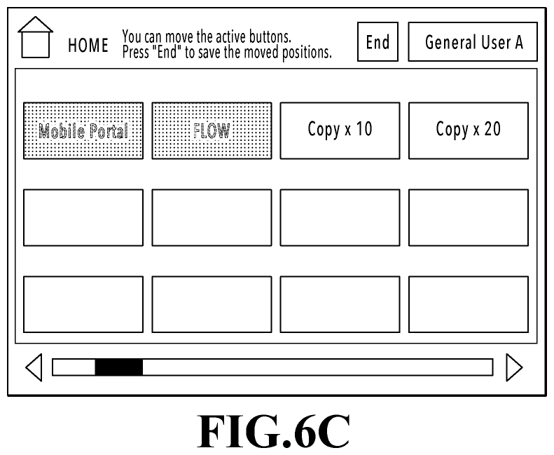

FIGS. 5A to 6A are diagrams illustrating screen transitions during a process of moving application buttons displayed on the home screen 302. FIG. 5A and FIGS. 5C to 6A illustrate the head (first) page of the home screen. FIG. 5B illustrates the second page of the home screen. Description of the same parts in FIGS. 5A to 6A as those in FIGS. 3A to 3F will be omitted.

In an area 504 in FIG. 5A, a currently logged-in user name is displayed. Specifically, FIGS. 5A to 6A illustrate a state where “General User A” is logged in. FIG. 5C illustrates the home screen 302 displaying the context menu 350 as a result of pressing the menu button 303 in FIG. 5A. The context menu 350 includes the movement button 351 to the background setting button 353, which are setting items for the home screen 302. The management setting button 354 to the movement attribute information management setting button 356 displayed in FIG. 3C are not displayed in FIG. 5C since they can be displayed only in a case where the administrator is logged in. These buttons may be either hidden or displayed as disabled.

FIG. 5D illustrates a state where application buttons displayed on the home screen 302 have become movable on the home screen as a result of pressing the movement button 351 in FIG. 5C (button moving mode). In the button moving mode, guidance 561 indicating that the mode has transitioned to the button moving mode, and the end button 362 for confirming the positions of the buttons are displayed. The guidance 561 displays a message indicating that the application buttons can be moved to change the layout of the application button display area 310. For example, a message “You can move the active buttons. Press “End” to save the moved positions.” or the like is displayed. Application buttons 571, 572, 575, 576, 579, and 580 whose movement attribute information is set such that the application buttons are immovable are displayed in a muted color, grayed out, semi-transparently, or in another similar fashion. This display indicates that the application buttons set to be immovable are not selectable (unable to receive drag and drop). On the other hand, application buttons 573, 574, 577, 578, 581, and 582 whose movement attribute information is set such that the application buttons are movable are displayed in a normal button color, indicating that they are selectable (able to receive drag and drop).

In the button moving mode, the user can perform an operation of moving application buttons to change the layout of the application buttons included in the menu. For example, in a case where the position of a pointer is moved in the button moving mode in a state where an application button is pressed by the pointer, the application button is displayed following the pointer. That is, the predetermined application button can receive a drag operation. Also, in a case where the predetermined application button transitions from a state of being pressed by a pointer to a state of not being pressed by the pointer, the predetermined application button is placed and displayed at the position at which it stopped being pressed by the pointer. That is, the predetermined application button can receive a drop operation. Also, in a case where, for example, a general user has switched the mode to the button moving mode from the normal mode, the administrator can log in, switch the mode to the movement attribute information setting mode, and change the movement attribute information of the predetermined application buttons.

FIG. 5E is a diagram illustrating a state where the application button 578 illustrated in FIG. 5D is overlapping the application button 573 illustrated in FIG. 5D as a result of being subjected to a drag operation. Specifically, FIG. 5E illustrates a state where the application button which a user has started dragging (the application button 578 subjected to a drag operation) is displayed following the user's drag operation (the position (coordinates) of the user's finger) (dragged state). Note that the application button 578 will return to its original position (the position of the application button 578 in FIG. 5D) in a case where the application button 578 is dropped in a state of overlapping the application button 571 with the movement attribute information “immovable” or the like.

FIG. 5F is a diagram illustrating the screen transition on the home screen 302 in a case where the application button 578 in the dragged state in FIG. 5E is subjected to a drop operation in a state of overlapping the application button 573. Note that the home screen 302 in FIG. 5F is in the button moving mode, as with FIGS. 5D and 5E. The drop operation of the application button 578 moves the position of the application button 578 to the position of the application button 573 and moves the position of the application button 573 to the position of the application button 578. That is, the home screen 302 displays a state where the application buttons 578 and 573 are arranged with their positions swapped.

In the present embodiment, as illustrated in FIG. 5F, by performing a drag operation on an application button and performing a drop operation in a state where the application button overlaps another, the application buttons are moved to swap their positions. The method of moving application buttons is not limited to this. For example, the application buttons may be arranged such that their positions are shifted to the next position toward the lower right corner (in the Z direction on the home screen 302). Specifically, in a case where the application button 578 in FIG. 5E is subjected to a drop operation in the state of overlapping the application button 573, application buttons are moved as below. The application button 578 is arranged at the position of the application button 573, and the application button 573 is arranged at the position of the application button representing the “Print” function. The application button representing “Print” function is arranged at the position of the application button representing the “Shortcut to Settings/Registration” function. The application button representing the “Shortcut to Settings/Registration” function is arranged at the position of the application button 573. FIG. 6A is a screen illustrating the home screen 302 in the normal state after the user presses the end button 362 in the state illustrated in FIG. 5F (button moving mode) thereby terminating the button moving mode.

In FIGS. 6B and 6C, the setting value of the setting item 342 for making the pre-installed application buttons immovable is ON. In FIGS. 6B and 6C, in this state, the application buttons that are displayed by pressing the movement button 351 in FIG. 5C are illustrated on the home screen 302 in the button moving mode.

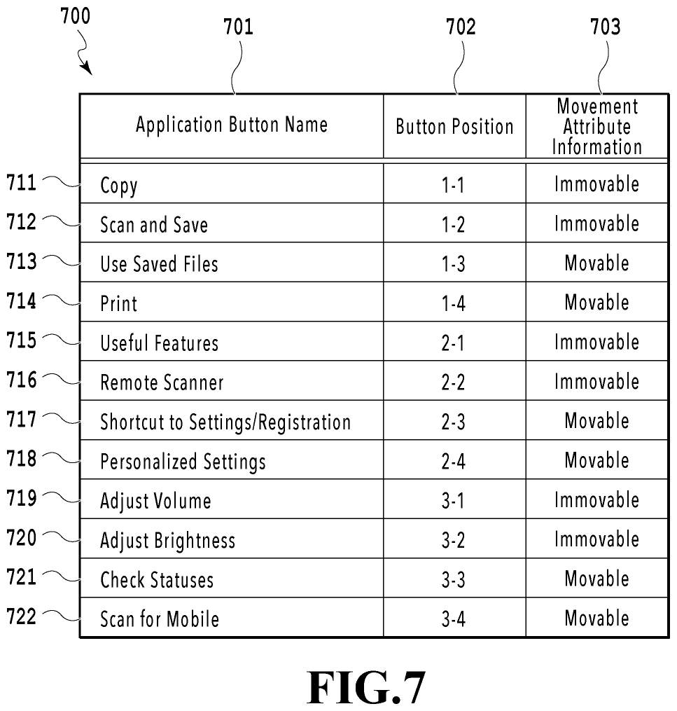

FIG. 7 is an information table stored in the HDD 103 which indicates the position of each application button to be displayed on the home screen. An information table 700 includes an application button name 701, button position information 702, and movement attribute information 703 of the application button. The button position information 702 illustrates the position at which to display the corresponding application button name 701. The left number indicates the position of the application button's row from the top in the home screen 302 while the right number indicates the position of the application button's column from the left in the home screen 302. That is, the button position information 702 is a set of numbers indicating a position from the left in a given row. For example, “1-1” indicates the position of the application button 311 with the application name “Copy” in FIG. 3A. The CPU 100 refers to the information table 700 and determines for each application button whether it is movable. In a case where the movement attribute information 703 is set to “Movable,” the application button is movable in the button moving mode. In a case where the movement attribute information 703 is set to “Immovable,” the application button is displayed in gray or in another similar fashion and movement of the application button is prohibited in the button moving mode.

FIG. 8 is a flowchart illustrating a process of setting the movement attribute information (configuring movement settings) of the application buttons displayed on the home screen 302. A program for executing the processing described in this flowchart is stored in the HDD 103 of the image processing apparatus 1, and is loaded to the RAM 102 and executed by the CPU 100. The processing of this flowchart is initiated in response to an instruction to display the menu button 303 for displaying the context menu 350 for the application buttons included in the application button display area 310 of the home screen 302.

In S801, the CPU 100 receives a user operation for displaying the context menu 350, and the processing proceeds to S802. In S802, the CPU 100 reads information in the RAM 102 and determines whether the logged-in user is the administrator. In a case where it is determined in S802 that the logged-in user is not the administrator, the processing proceeds to S803. In a case where it is determined in S802 that the logged-in user is the administrator, the processing proceeds to S804.

In S803, the CPU 100 displays the context menu 350 without the application button movement attribute information setting button 355. That is, the application button movement attribute information setting button 355 is not displayed. Thereafter, the CPU 100 terminates the processing of the flowchart.

In S804, the CPU 100 displays the application button movement attribute information setting button 355 in the context menu 350, and the processing proceeds to S805.

In S805, the CPU 100 detects a press on the application button movement attribute information setting button 355 included in the context menu 350, and the processing proceeds to S806. In S806, the CPU 100 transitions to the button movement attribute information setting mode, and the processing proceeds to S807.

In S807, the CPU 100 detects a press on one or more application buttons displayed in the application button display area 310. The CPU 100 updates the movement attribute information 703 of the pressed application buttons in FIG. 7 temporarily saved in the RAM 102, and applies the update to the displayed contents. Specifically, in a case where the administrator presses an application button whose movement attribute information has been “immovable” before the press, this application button is displayed in such a fashion as to be movable. Also, in a case where the administrator presses an application button whose movement attribute information has been “movable” before the press, this application button is displayed in such a fashion as to be immovable. Application buttons with movement attribute information set to “immovable” are displayed in a color reversed from that of application buttons with movement attribute information set to “movable”. After the movement attribute information of each application button indicating whether it is movable or not is set, the processing proceeds to S808.

In S808, the CPU 100 detects a press on the end button 362, and the processing proceeds to S809. In S809, the CPU 100 saves the movement attribute information of each application button indicating whether it is movable to the information table 700 stored in the HDD 103, and the processing proceeds to S810.

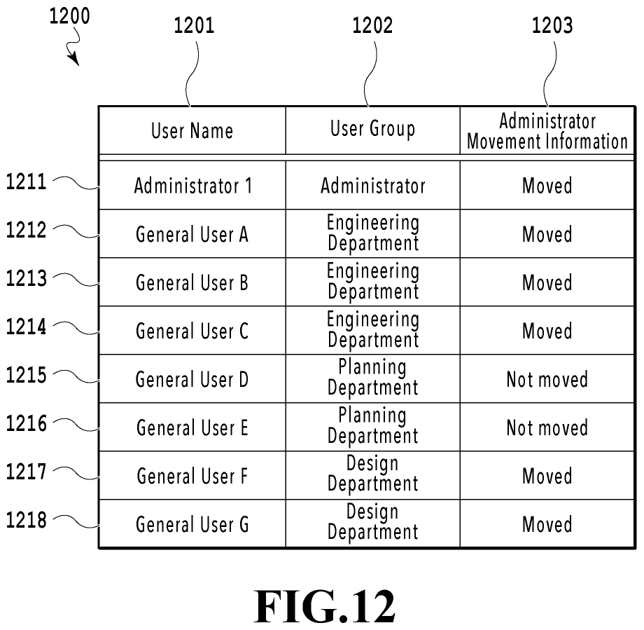

In S810, the CPU 100 changes the setting item 332 in FIG. 4C to ON in a case where the administrator has set the setting item 332 in FIG. 4C to OFF and set the setting item 345 in FIG. 4D to ON. This enables movement of the application buttons with movement attribute information set to “movable”. Further, the CPU 100 updates the movement attribute information 703 of each application button illustrated in FIG. 7 and applies the update to the displayed application button. Movement of application buttons may be enabled only for a predetermined user name or names 1201 or user group or groups 1202 in FIG. 12 to be described later. Details will be described in a second embodiment. After each application button is displayed according to the updated movement attribute information 703, the processing proceeds to S811. In S811, the CPU 100 terminates the movement attribute information setting mode, and terminates the processing of the flowchart illustrated in FIG. 8. Note that the process of S810 and the process of S811 in the flowchart illustrated in FIG. 8 may be executed in any order.

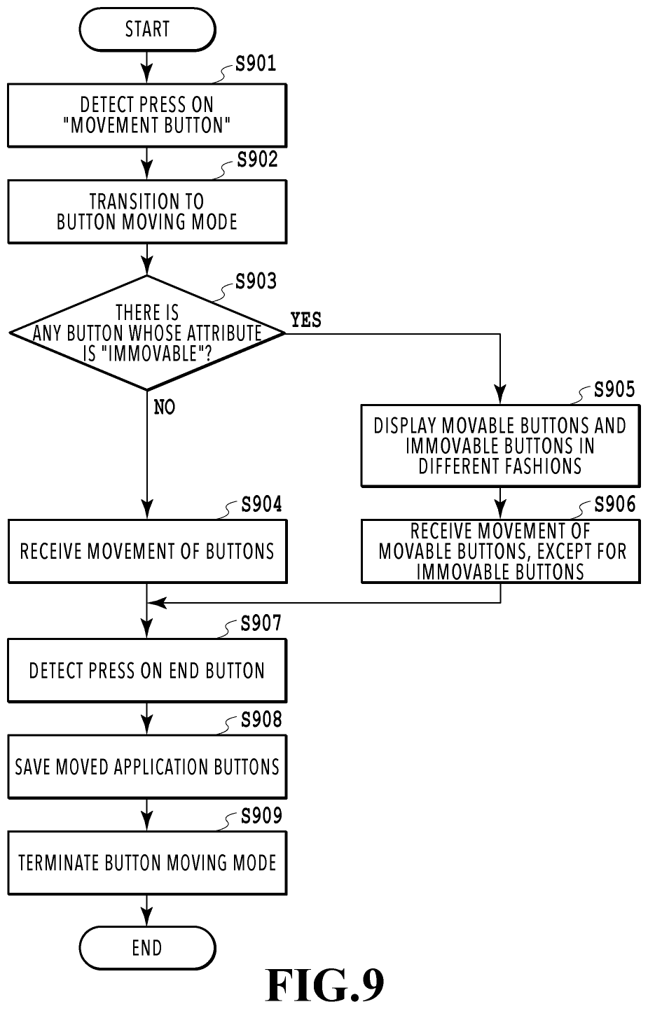

FIG. 9 is a flowchart illustrating a process of moving of application buttons displayed on the home screen 302. A program for executing the processing described in this flowchart is stored in the HDD 103 of the image processing apparatus 1, and is loaded to the RAM 102 and executed by the CPU 100.

In S901, the CPU 100 detects a press on the movement button 351, and the processing proceeds to S902. In S902, the CPU 100 switches to the button moving mode, and the processing proceeds to S903. In S903, the CPU 100 reads the movement attribute information 703 out of the HDD 103 and determines whether there are any application buttons with the movement attribute information “immovable”. In a case where it is determined that there is no application button with the movement attribute information “immovable,” the processing proceeds to S904. In a case where it is determined that there is one or more application buttons with the movement attribute information “immovable,” the processing proceeds to S905.

In S904, the CPU 100 receives a user operation on one or more application buttons for moving the application button, and the processing proceeds to S907. In S905, the CPU 100 displays the application buttons with the movement attribute information “immovable” and the application buttons with the movement attribute information “movable” in different fashions according to the movement attribute information 703 read out of the HDD 103. For example, the names indicating the functions of the application buttons with movement attribute information set to “immovable” as well as their icons and the frames surrounding them are displayed like the application buttons 571, 572, 575, 576, 579, and 580 in FIG. 5D. That is, these application buttons are displayed in a muted color, grayed out, semi-transparently, or in another similar fashion to be presented in such a state that they cannot be selected (dragged and dropped). Also, the names indicating the functions of the application buttons with movement attribute information set to “movable” as well as their icons and the frames surrounding them are displayed like the application buttons 573, 574, 577, 578, 581, and 582 in FIG. 5D.

In S906, the CPU 100 detects a press on one or more application buttons with the movement attribute information “movable”, and receives movement of the application buttons with the movement attribute information “movable”. Specifically, the CPU 100 detects that an application button with the movement attribute information “movable” is selected, subjected to a drag operation, and subjected to a drop operation in a state of overlapping another application button with the movement attribute information “movable”. For example, the CPU 100 detects a drag-and-drop operation for swapping the positions of application buttons with the movement attribute information “movable”. Alternatively, in response to detecting a drag-and-drop operation on an application button with the movement attribute information “movable,” the CPU 100 may arrange other application buttons with the movement attribute information “movable” such that their positions are moved to next positions. Note that the operation of moving an application button does not need to be a drag-and-drop operation. For example, an application button may be moved in response to an operation of selecting the application button to be moved and an operation of selecting a destination application button. The method of displaying the application buttons moved in this case may also be such that application buttons are moved to next positions on the home screen 302 in the Z direction or such that the positions of the selected application buttons are swapped.

In S907, the CPU 100 detects a press on the end button 362, and the processing proceeds to S908. In S908, the CPU 100 saves the layout information of the moved application buttons to the information table 700 stored in the HDD 103, and the processing proceeds to S909. In S909, the CPU 100 terminates the button moving mode and terminates the processing of the flowchart illustrated in FIG. 9.

According to the present embodiment, for one or more application buttons displayed on a home screen, movement attribute information indicating whether to make the application buttons movable can be set and changed. Specifically, the home screen 302 in the present embodiment includes both application buttons whose layout (positions) are changeable and application buttons whose layout (positions) are unchangeable. In this way, even in a case where the home screen includes application buttons that are desired not to be moved by the administrator and application buttons that may be moved by the administrator, it is possible to set, for each application button, whether it is movable or not. This allows the user to move the positions of movable application buttons and thus improves user-friendliness. Accordingly, it is possible to more flexibly set the movement attributes of application buttons.

### Second Embodiment

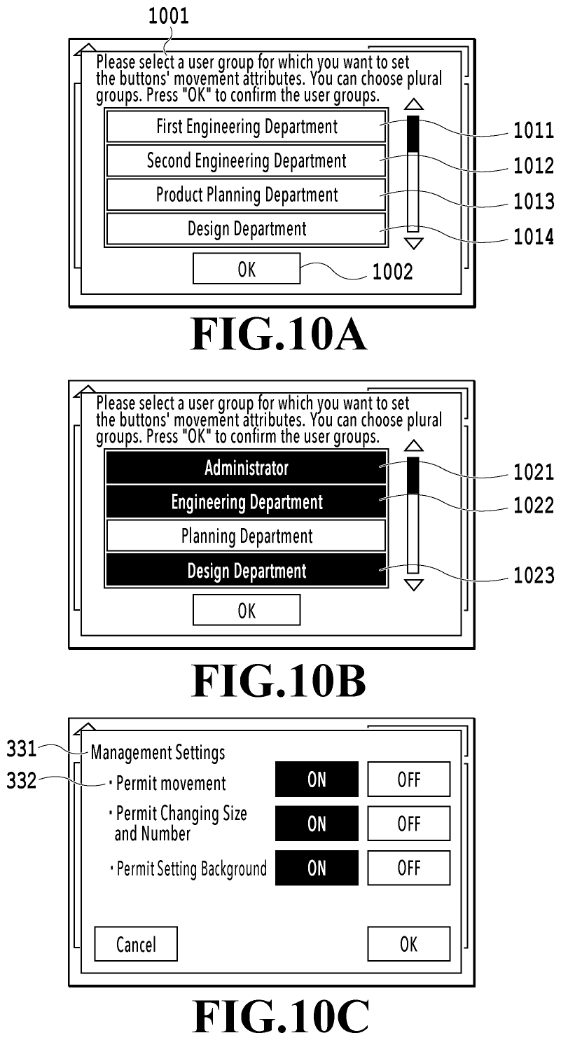

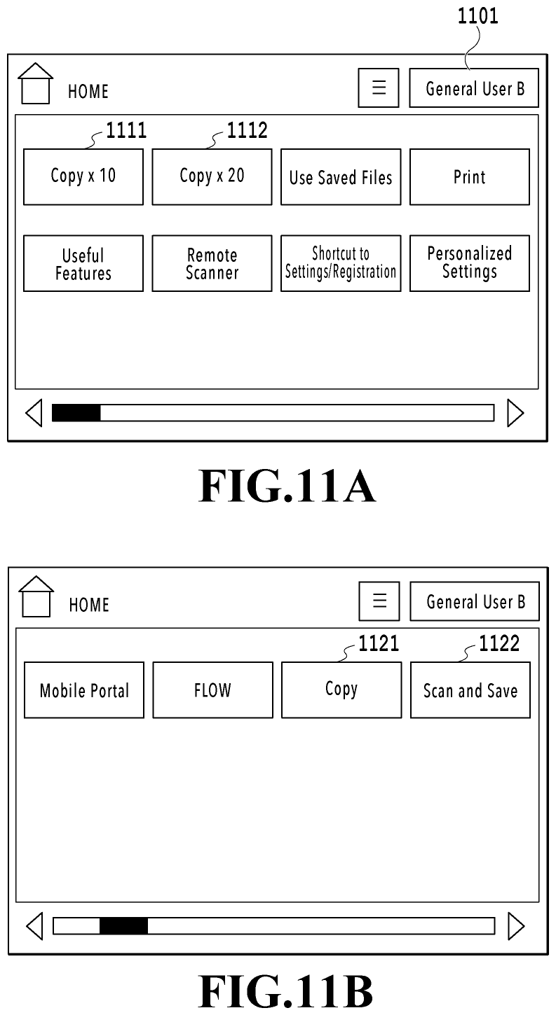

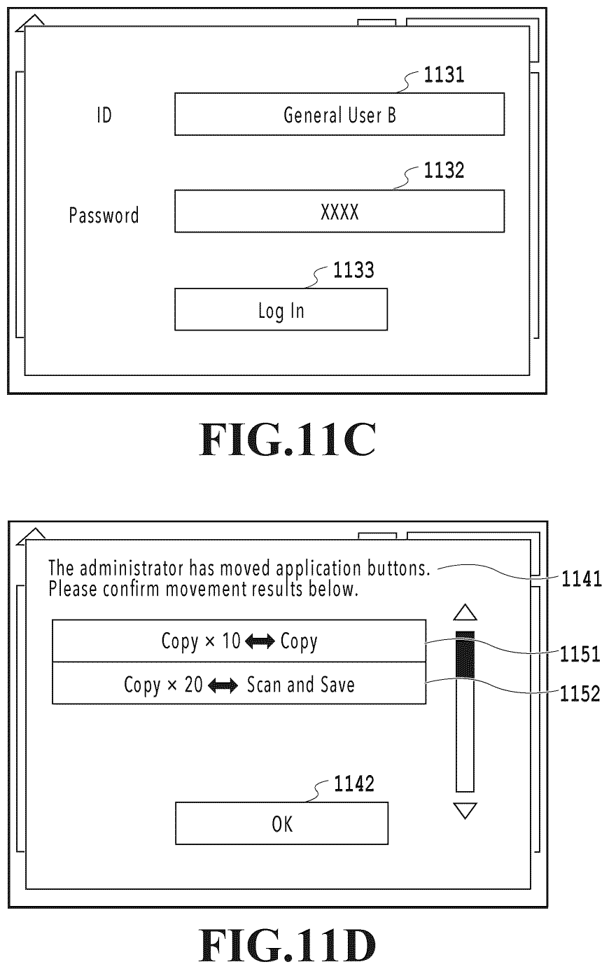

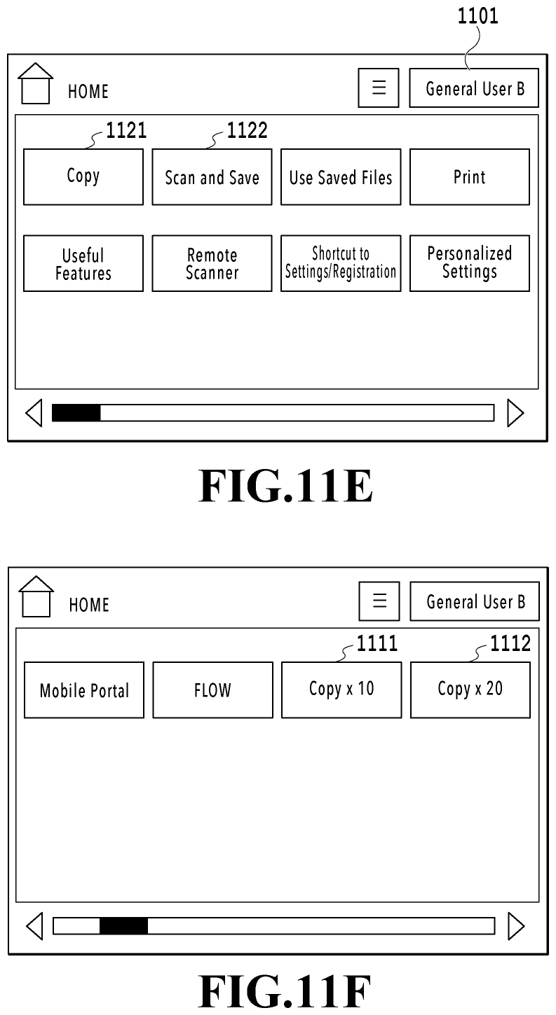

A second embodiment will describe a case where an administrator has permitted general users to move application buttons, and a process of changing the movement attribute information of application buttons is performed after a general user freely changes the layout. FIG. 10C to be described later illustrates a state where the administrator has permitted general users to move application buttons, and FIGS. 11A and 11B to be described later illustrate a state where a general user has moved application buttons. The description will be given of screens displayed in a case where, the administrator performs an operation for changing the movement attribute information of application buttons arranged on the home screen 302 in the above state, and a general user moves application buttons. The description starts from a state where the movement attribute information setting button 355 in FIG. 3C in the first embodiment is pressed.

FIG. 10A is a screen that is displayed by pressing the movement attribute information setting button 355, and displays user groups for whom to set movement attribute information. The user groups may be user roles or may be displayed on a user-by-user basis. Guidance 1001 indicates that user groups can be selected. Additionally, an OK button 1002 for confirming user groups is displayed on the screen. Also, user groups 1011 to 1014 are displayed in the form of a list of selectable user groups.

FIG. 10B displays a state where the user groups 1011, 1012, and 1014 on the screen in FIG. 10A are selected. Pressing the OK button 1002 in this state displays the screen in FIG. 3D in the first embodiment. After this, movement attribute information can be set through the same procedure as that in the first embodiment. FIG. 10C illustrates a state where the setting value of the setting item 332 for setting whether to permit movement of application buttons is changed to ON from the state of FIG. 4C. In this state, users other than the administrator can move application buttons as well.

FIGS. 11A and 11B illustrate a state where a general user B is logged in and has swapped the following application buttons in the layout of application buttons determined by the administrator. Application buttons 1111 and 1112 have been swapped with application buttons 1121 and 1122, respectively.

FIG. 11C illustrates the state of a screen on which the general user B is logging in in a state where the movement attribute information has been set as in FIG. 5F for the user groups 1011, 1012, and 1014 in FIG. 10B. The screen in FIG. 11C includes a logging-in user input area 1131, a password input area 1132, and a login button 1133. Pressing the login button 1133 with the correct login user ID and the correct password input executes a login process.

FIG. 11D is a screen that is displayed in a case where the login process is executed in the state of FIG. 11C. Guidance 1141 indicates that the administrator has moved application buttons. In addition, the screen in FIG. 11D displays an OK button 1142 for receiving movement results 1151 and 1152 in the form of a list. Also, FIGS. 11E and 11F illustrate a state where the administrator has moved application buttons. Specifically, the layout of the application buttons 1111 and 1121 and the layout of the application buttons 1112 and 1122 have been re-set.

FIG. 12 is an information table 1200 in a state where the movement attribute information has been set as in FIG. 5F for the user groups 1011, 1012, and 1014 in FIG. 10B. The information table 1200 includes user names 1201, user groups 1202, and administrator movement information 1203 as its items. Users 1211 to 1218 included as the user names 1201 each represent information to be displayed in the logging-in user input area 1131 of the home screen and the like. Also, the user groups 1202 indicate the user groups to which the users 1211 to 1218 belong. The administrator movement information 1203 indicates whether the administrator has moved application buttons.

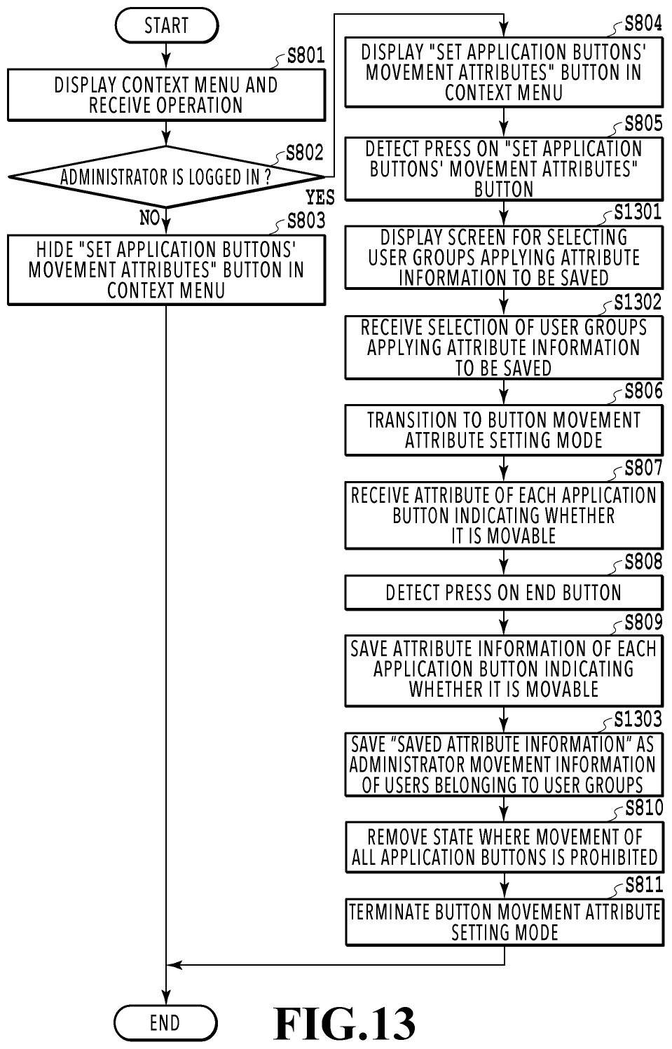

FIG. 13 is a flowchart illustrating a process of changing of the movement attribute information of application buttons displayed on the home screen 302. Description of the same portions of the process flow as those of the process flow described with reference to FIG. 8 will be omitted.

In S1301, the CPU 100 displays a screen for selecting user groups to which to apply the movement attribute information to be saved, and the processing proceeds to S1302. In S1302, the CPU 100 receives selection of one or more user groups to which to apply the movement attribute information to be saved from among the user groups 1011 to 1014, and detects a press on the OK button 1002. In response to the detection of a press on the OK button 1002, the processing proceeds to S806. After the process of S809 is executed, the processing proceeds to S1303. In S1303, the CPU 100 stores the saved movement attribute information to the HDD 103 as the administrator movement information 1203 for the users belonging to the user groups, and the processing proceeds to S810.

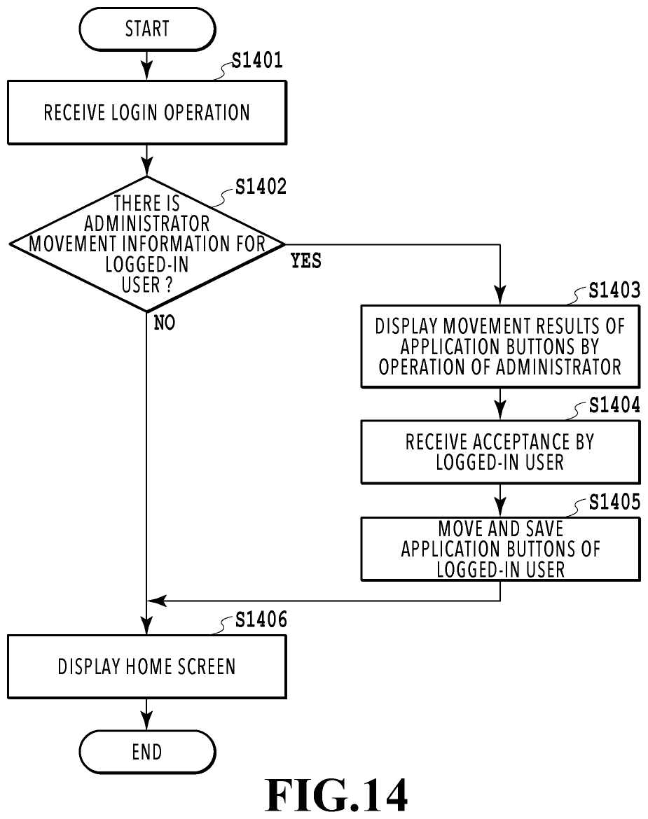

FIG. 14 illustrates a flowchart in which the following processing is performed in a state where a general user has moved application buttons. Processing for the home screen 302 displayed to a general user in a case where the administrator has changed the movement attribute information of application buttons arranged on the home screen and changed the positions of application buttons. Note that the processing of this flowchart can be followed by the process of moving application buttons illustrated in FIG. 9.

In S1401, the CPU 100 detects a login operation, and the processing proceeds to S1402. In S1402, the CPU 100 scans the HDD 103 and determines whether there is administrator movement information for the user. In a case where it is determined that there is administrator movement information, the processing proceeds to S1403. In a case where it is determined that there is no administrator movement information, the processing proceeds to S1406.

In S1403, based on the administrator movement information, the CPU 100 reads the layout information of the application buttons for the logged-in user and the movement attribute information and layout information set for the user group to which the logged-in user belongs out of the HDD 103. After reading out these pieces of information, the CPU 100 detects the difference between the pieces of layout information of the application buttons and displays it on a screen.

In S1404, the CPU 100 detects an acceptance operation by the logged-in user, and the processing proceeds to S1405. In S1405, the CPU 100 re-sets the layout of the application buttons according to the movement attribute information and layout information set for the user group, which are stored in the HDD 103, and stores the movement attribute information of the application buttons to the HDD 103. After the movement attribute information of the application buttons is stored to the HDD 103, the processing proceeds to S1406.

In S1406, in the case where there is administrator movement information, the CPU 100 displays the application buttons whose layout has been re-set in S1405 on the home screen. Then, the CPU 100 terminates the process flow in the flowchart illustrated in FIG. 14.

The present embodiment assumes a state where the administrator has permitted general users to move application buttons, and a general user has moved application buttons. In a case where the administrator desires to limit the movement attribute information and layout information of the application buttons for general users from the above state, means for changing settings and a screen that provides an explanation to the general user are provided. Accordingly, it is possible to restrict movement of application buttons even in a state where a general user has moved application buttons, and therefore to more flexibly set the movement attributes of application buttons.

### OTHER EMBODIMENTS

The present disclosure can also be implemented through processing including supplying a program for implementing one or more functions of the embodiments described above to a system or an apparatus by using a network or a storage medium, and reading and executing, by a computer of the system or the apparatus, the program. The computer includes one or a plurality of processors or circuits, and may include a network of a plurality of individual computers or a plurality of individual processors or circuits, to read and execute a computer-readable instruction.

The processor or circuit may include a central processing unit (CPU), a micro processing unit (MPU), a graphics processing unit (GPU), an application specific integrated circuit (ASIC), or a field-programmable gate array (FPGA). Moreover, the processor or circuit can include a digital signal processor (DSP), a data flow processor (DFP), or a neural processing unit (NPU).

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-111066, filed Jul. 10, 2024, which is hereby incorporated by reference herein in its entirety.

What is claimed is:

1. An information processing apparatus with a plurality of functions comprising one or more processors and/or circuitry which function as:
a display control unit configured to display an application button representing a function among the plurality of functions in a predetermined area;
a moving unit configured to move positions of a plurality of the application buttons displayed by the display control unit; and
a setting unit configured to, for each of the plurality of application buttons displayed in the predetermined area, set a movement setting indicating whether the application button is movable, wherein,
in a case where an operation of moving a first application button, which is included within the predetermined area and is set to be movable by the setting unit, is received, the moving unit executes control to move the first application button and not to move a second application button being the application button included within the predetermined area and set to be immovable by the setting unit.

2. The information processing apparatus according to claim 1, wherein
the one or more processors and/or circuitry further function as a mode change unit configured to transition to a mode in which an operation of moving one or more of the application buttons is receivable, wherein,
in a case of transitioning to the mode in which an operation of moving one or more of the application buttons is receivable, the display control unit displays the first application button and the second application button in different fashions.

3. The information processing apparatus according to claim 2, wherein the display control unit displays the first application button in a selectable fashion and displays the second application button in an unselectable fashion.

4. The information processing apparatus according to claim 1, wherein the movement setting is settable by the setting unit in a case where an administrator user having different authority from authority given to a general user is logged in to the information processing apparatus.

5. The information processing apparatus according to claim 3, wherein the one or more processors and/or circuitry further function as a control unit configured to, in a case where a setting that does not permit movement of the application buttons is enabled and the setting unit has completed setting the movement setting, perform control to disable the setting that does not permit movement of the application buttons.

6. The information processing apparatus according to claim 5, wherein the control unit performs control to move the first application button to a predetermined position at which the application button set to be movable by the movement setting is arranged in a case where a user operation is performed as an operation of moving the first application button to the predetermined position, and not to move the first application button to a particular position at which the application button set to be immovable by the movement setting is arranged in a case where a user operation is performed as an operation of moving the first application button to the particular position.

7. The information processing apparatus according to claim 6, wherein the control not to move the first application button to the particular position is control to perform an operation of returning the first application button to an original position even in a case where the operation of moving the first application button to the particular position is performed.

8. The information processing apparatus according to claim 1, wherein
the setting unit is capable of setting a size and number of the application buttons per screen, and
the display control unit displays the application buttons based on the size and number of the application buttons per screen set by the setting unit.

9. The information processing apparatus according to claim 1, wherein the setting unit is capable of setting the movement setting with a same content for the application buttons arranged at a same position on a plurality of different screens.

10. The information processing apparatus according to claim 1, wherein the setting unit is capable of setting the movement setting for an area where a function of the information processing apparatus is allowed to be arranged but is not arranged.

11. The information processing apparatus according to claim 8, wherein the setting unit is capable of setting, for each of the application buttons of all pre-installed applications, whether to allow movement of the application button of the pre-installed application.

12. The information processing apparatus according to claim 1, wherein in a case where a general user who is different from an administrator user logs in to the information processing apparatus and sets a layout of the application buttons with a user operation, and the administrator user changes the layout of the application buttons set by the general user, the display control unit displays the layout of the application buttons changed by the administrator user.

13. A method of controlling an information processing apparatus with a plurality of functions, comprising:
displaying an application button representing a function among the plurality of functions in a predetermined area;
moving positions of a plurality of the application buttons displayed in the displaying; and
for each of the plurality of application buttons displayed in the predetermined area, setting a movement setting indicating whether the application button is movable, wherein
the moving includes, in a case where an operation of moving a first application button, which is included within the predetermined area and is set to be movable in the setting, is received, executing control to move the first application button and not to move a second application button being the application button included within the predetermined area and set to be immovable in the setting.

14. A non-transitory computer readable storage medium storing a program which causes a computer to execute a method of controlling an information processing apparatus with a plurality of functions, the method comprising:
displaying an application button representing a function among the plurality of functions in a predetermined area;
moving positions of a plurality of the application buttons displayed in the displaying; and
for each of the plurality of application buttons displayed in the predetermined area, setting a movement setting indicating whether the application button is movable, wherein
the moving includes, in a case where an operation of moving a first application button, which is included within the predetermined area and is set to be movable in the setting, is received, executing control to move the first application button and not to move a second application button being the application button included within the predetermined area and set to be immovable in the setting.
